(19) United States
(12) Patent Application Publication
(10) Pub. No.: US 2017/0270468 A1
(43) Pub. Date: Sep. 21, 2017

(54) SYSTEM AND METHOD FOR GENERATING SHIPPING OPTIONS

(71) Applicant: Wal-Mart Stores, Inc., Bentonville, AR (US)

(72) Inventors: Chandrashekar Natarajan, San Ramon, CA (US); Donald R. High, Noel, MO (US); John J. O'Brien, V, Farmington, AR (US); Robert Cantrell, Herndon, VA (US)

(21) Appl. No.: 15/461,592

(22) Filed: Mar. 17, 2017

Related U.S. Application Data
(60) Provisional application No. 62/311,011, filed on Mar. 21, 2016.

(51) Int. Cl. G06Q 10/08; G06Q 30/02; G06N 5/04; G06Q 30/08

(52) U.S. Cl. CPC G06Q 10/083; G06Q 30/08; G06Q 30/0283; G06N 5/04

(57) ABSTRACT

A shipping options system comprises a shipping options engine that generates a plurality of store item delivery options in response to a set of assessment criteria and generates a bid request in response to the delivery options; and an auctioning engine that receives the bid request from the shipping options engine, and submits the bid request to at least one carrier according to a comparison between a carrier score and capabilities of the carrier to satisfy the bid request.

### RELATED APPLICATIONS

This application claims the benefit of U.S. Provisional Patent No. 62/311,011, filed Mar. 21, 2016, the contents of which are incorporated herein in its entirety.

### FIELD

The present inventive concepts relate generally to shipping as a service (SaaS), and more specifically to systems and methods for providing an ecosystem of shipping options based on a set of customer-specified criteria.

### BACKGROUND

Retail establishments that sell goods or commodities to consumers electronically over the Internet, referred to as e-commerce retailers or “e-tailers,” provide many different delivery options. However, it is difficult for a consumer to understand which shipping option is the best option for a particular purchase.

Often, the shipping fee paid by a consumer is linked to the purchase price. For example, a consumer who purchases an item from an e-commerce website may pay less money for a product than a brick-and-mortar store customer but pay a higher shipping cost. In some instances, the store customer may be provided few or no delivery options for items purchased at the store. On the other hand, the online consumer may be offered free shipping for an item, for example, as part of a promotion, but pay full price for the item. Also, the consumer is typically limited to a particular carrier when purchasing an item from a store who has a contract with the carrier, with no opportunity to consider other carriers who may provide a lower shipping fee notwithstanding the price paid for the product to be shipped.

### BRIEF SUMMARY

In one aspect, provided is a method for shipping, comprising: providing two or more assessment criteria; generating, by a shipping options engine, a first set of delivery options constructed and arranged as a recommended customer shipping matrix from the received assessment criteria; receiving a customer request regarding a product order; receiving a request for at least one customer shipping preference; and presenting, in response to the customer request and the at least one customer shipping preference, a second set of delivery options and pricing corresponding to the delivery options. In other embodiments, all shipping options are available for the customer, which includes more than two shipping options.

In another aspect, provided is a shipping options system, comprising: a shipping options engine that generates a plurality of store item delivery options in response to a set of assessment criteria and generates a bid request in response to the delivery options; and an auctioning engine that receives the bid request from the shipping options engine, and submits the bid request to at least one carrier according to a comparison between a carrier score and capabilities of the carrier to satisfy the bid request.

In some embodiments, the shipping options system further comprises a customer artificial intelligence (AI) engine that generates and outputs a recommended option to the shipping options engine, wherein the bid request is generated in response to the recommended option.

In some embodiments, the customer AI engine monitors customer shipping preferences, determines analytics from the customer shipping preferences, and generates the recommended option in response to a determined analytic result.

In some embodiments, the customer AI engine comprises: a preference tracking module that processes shipping history data and analyzes customer shipping preferences for determining analytic data; a learned preference generator that processes purchase history data; and a data processor that outputs the recommended option in response to the processed purchase history data and shipping history data.

In some embodiments, the shipping options engine selects either the recommended option or a customer preference request for generating the store item delivery options.

In some embodiments, data processed that at the customer AI engine is presented as the recommended option, and wherein the shipping options engine generates the store item delivery options in response to an output of the customer AI engine.

In some embodiments, the shipping options engine comprises: a delivery pathway options determination module that computes the delivery options in response to the set of assessment criteria; and a delivery option selection module that selects for a bid request at least one delivery option from the plurality of delivery options.

In some embodiments, the delivery pathway options determination module generates at least one recommended customer delivery pathways matrix from the assessment criteria, and populates the matrix with combinations of the delivery options.

In some embodiments, the shipping options system further comprises a shipping option alignment processor that aligns the shipping options with contents of a shipper and customer alignment matrix, or aligns the shipper's potential delivery methods with the customer's chosen pathways and modes for shipping, for identifying customer-preferred shipping options.

In some embodiments, the shipping options system further comprises a transparency engine that receives a combination of the data of a shipping options and savings matrix, information from shipping mode and cost matrix data, a carrier shipper quote, and a carrier feedback rating, and generates as an output information regarding: all available costs, shipping options, convenience options, delivery duration and windows, carrier feedback, carrier services, carrier qualifications, and incentives.

In some embodiments, the shipping options system further comprises a pricing engine that calculates pricing options corresponding to the plurality of store item delivery options.

In some embodiments, the pricing engine comprises a pricing model adjuster that changes shipping prices for the delivery options in response to data related to the delivery options.

In some embodiments, the shipping options system further comprises a product returns system for processing a product return in response to a carrier notification.

In some embodiments, the auctioning engine that generates the carrier score from a carrier profile.

In some embodiments, the assessment criteria include convenience factors, including at least one of time of day, location, frequency, hot, cold, or special handling, and wherein pricing increases for the convenience factors.

In another aspect, provided is a method for shipping, comprising: providing two or more assessment criteria; generating, by a shipping options engine, a first set of delivery options constructed and arranged as a recommended customer shipping matrix from the received assessment criteria; receiving a customer request regarding a product order; receiving a request for at least one customer shipping preference; and presenting, in response to the customer request and the at least one customer shipping preference, a second set of delivery options and pricing corresponding to the delivery options.

In some embodiments, the method further comprises receiving by a customer artificial intelligence engine shipping history data and purchasing history data that include learned and gather information; and generating by the customer artificial intelligence engine a recommended shipping option of the first set of delivery options.

In some embodiments, the customer artificial intelligence engine collects data over time, and generates a recommended shipping option on behalf of the customer and instead of a customer directed shipping option.

In some embodiments, the assessment criteria are provided for computing the delivery options, and wherein the assessment criteria are organized into categories and subcategories which are processed by a shipping options engine.

In some embodiments, the method further comprises providing to one or more prospective carriers or shippers of the order product a request for bid based on the customer preferences and delivery options; and submitting, by prospective carriers or shippers of the ordered product, bids to deliver the ordered product to the customer based on the customer preferences and the delivery options.

In some embodiments, the delivery options are adjusted by the carriers or shippers by providing incentives as part of the bids.

In some embodiments, the assessment criteria include a duration window, wherein the smaller the window or the more popular that window of time.

In some embodiments, providing the pricing includes at least one of: calculating pricing options from shipping options; calculating available incentives and promotions and adjusts pricing model; recording a history of pricing selected for future pricing options; and aligning shipping options with customer preferences for lowest shipping.

In another aspect, provided is a method for shipping, comprising: computing by a shipping options engine an ecosystem of shipping options, shippers, and bids matrix that includes a set of possible combinations and initial pricing; receiving a customer request; presenting in response to the customer request shipping options in a set of possible combinations and initial pricing; and generating available shipping options based upon match on customer preferences in the customer request.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a network diagram in which embodiments of systems and methods for shipping as a service (SaaS) are employed.

FIG. 2 is a block diagram of a shipping options engine, in accordance with some embodiments.

FIG. 3 is a diagram of a recommended customer shipping matrix, in accordance with some embodiments.

FIG. 4 is a block diagram of a customer artificial intelligence (AI) engine, in accordance with some embodiments.

FIG. 5 is a block diagram of a pricing engine, in accordance with some embodiments.

FIG. 6 is a diagram illustrating a shipping options and savings matrix, in accordance with some embodiments.

FIG. 7 is a flowchart of a method for determining shipping options, in accordance with some embodiments.

FIGS. 8-16 are flow diagrams of a shipping as a service (SaaS) process, in accordance with some embodiments.

### DETAILED DESCRIPTION

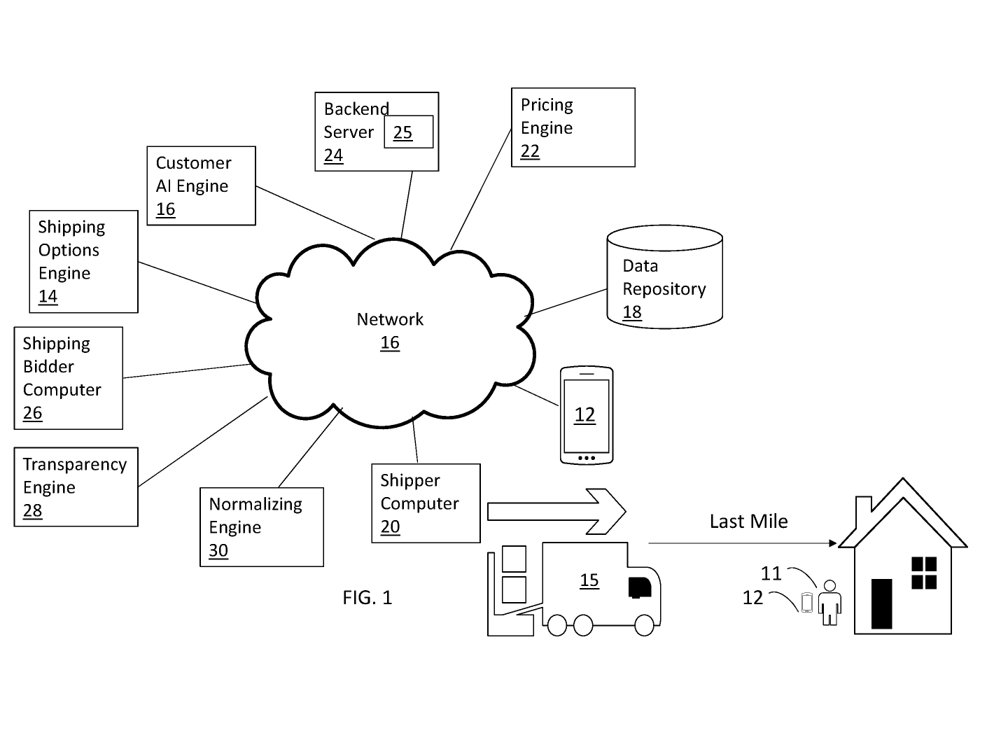

FIG. 1 is a network diagram in which embodiments of systems and methods for shipping as a service (SaaS) are employed. Although SaaS is described, embodiments of the inventive concepts may also apply to cost-related features, for example, every day low shipping. Accordingly, the inventive concepts provide a store customer with the lowest options for shipping and best available service. It also considers other factors including duration windows, timing, special handling, and so on.

A SaaS system may include a shipping options engine 14, a customer artificial intelligence (AI) engine 16, and a pricing engine 22. The SaaS system may also include a backend server 24 having an auctioning engine 25, and may also include a transparency engine 28, and/or a normalizing engine 30. Some or all of the shipping options engine 14, customer artificial intelligence (AI) engine 16, pricing engine 22, backend server 24, transparency engine 28, and normalizing engine 30 can be part of a same hardware platform. In other examples, as shown in FIG. 1 the foregoing SaaS system elements are separate hardware devices and communicate with each other via a network 16. Other devices that communicate with the SaaS system via the network 16 may include but not be limited to a customer electronic device 12 such as a smartphone, laptop computer, or the like, data repository 18, shipper computer 20, and bidder electronic device 26. In some embodiments, the shipper computer 20 and bidder electronic device 26 are the same. The network 16 may be a public switched telephone network (PSTN), a mobile communications network, a data network, such as a local area network (LAN) or wide area network (WAN), or a combination thereof, or other communication network known to those of ordinary skill in the art.

The shipping options engine 14 generates a set of delivery options constructed and arranged as an array, matrix, table, or related structures from assessment criteria, which can be used to provide a store customer with shipping options, for example, one or more recommended shipping channels or last mile pathways, for example, by a delivery truck 15. For example, the shipping options engine 14 may compute possible combinations of shipping options, which are pre-generated for a customer 11. Assessment criteria can be organized into categories which are processed by the shipping options engine 14. Each category may be further organized into subcategories. This matrix is specific to the customer's learned data or inputted data and doesn't account for the shipper's fulfillment potential; although, previous deliveries fulfilled by shippers will be included within the customer's AI, and may be referred to as a recommended customer shipping matrix, which receives inputs from the recommended customer delivery pathways.

Assessment criteria may include one or more convenience factors, including at least one of time of day, duration window, order size, location, frequency, hot, cold, or special handling, price, speed of delivery, and so on.

For example, the system can create customer convenience, by time the last mile pathways for every product category by market. Convenience factors may include but not be limited to time of day, location, frequency, hot, cold, special handling which increases the cost, and so on. Delivery by time may be a duration window where the smaller the window or the more popular that window of time, the higher the cost, e.g., high volume windows require more resources from cloud carriers.

Assessment criteria can be organized into following categories: rating, classification, product care and assortment, time, convenience and shipping mode, incentives, quantities, and available carrier services. After these categories have been processed through the assessment criteria, available shipping results will be presented from the inputted factors. Also, dynamic alerts may be processed, or parsed, for output to both carriers and customers, altering any and all changes. From the categories mentioned, the assessment criteria can be further broken down into the following subcategories:

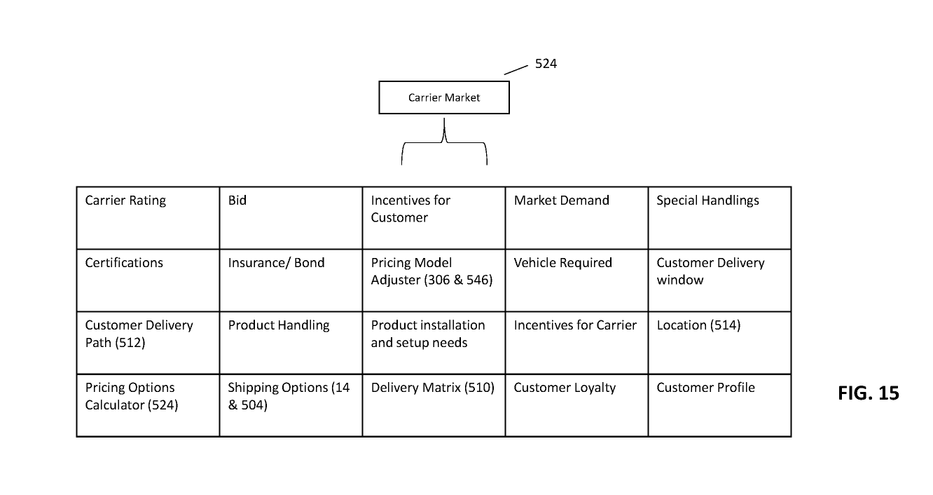

A rating criteria may include a carriers rating (see for example, FIG. 15, block 572). This information may displayed within a matrix, which is specific to the carrier and their profile, which is stored information from customer's responses to the carrier's fulfillment, also referred to as a carrier scorecard matrix (described herein), providing the customer with the rating feedback stores gathered for the assessment criteria.

A classification criteria where a carriers' product handling classification is assessed as a subcategory. The special classifications the carriers hold will be presented to the customer, providing them with their limitations for the types of packages they can deliver.

Product care and assortment criteria where crush, temperature, weight, handling and security may be assessed as subcategories.

Time options where speed duration, schedule window, time of arrival and time of pickup may be assessed as subcategories.

Convenience and shipping mode criteria where pickup, drive thru, delivery, remote and autonomous delivery may be assessed as a subcategory;

Incentives where promotions, services, introductory special offers, group discounts, reoccurring and subscription may be assessed as a subcategory.

Quantities where money, size, frequency, subscription for product and shipping may be assessed as a subcategory.

Carrier services where guarantees for delivery, certification of delivery, attended or unattended delivery and pickup, wait time, product care and temperature may be assessed as a subcategory.

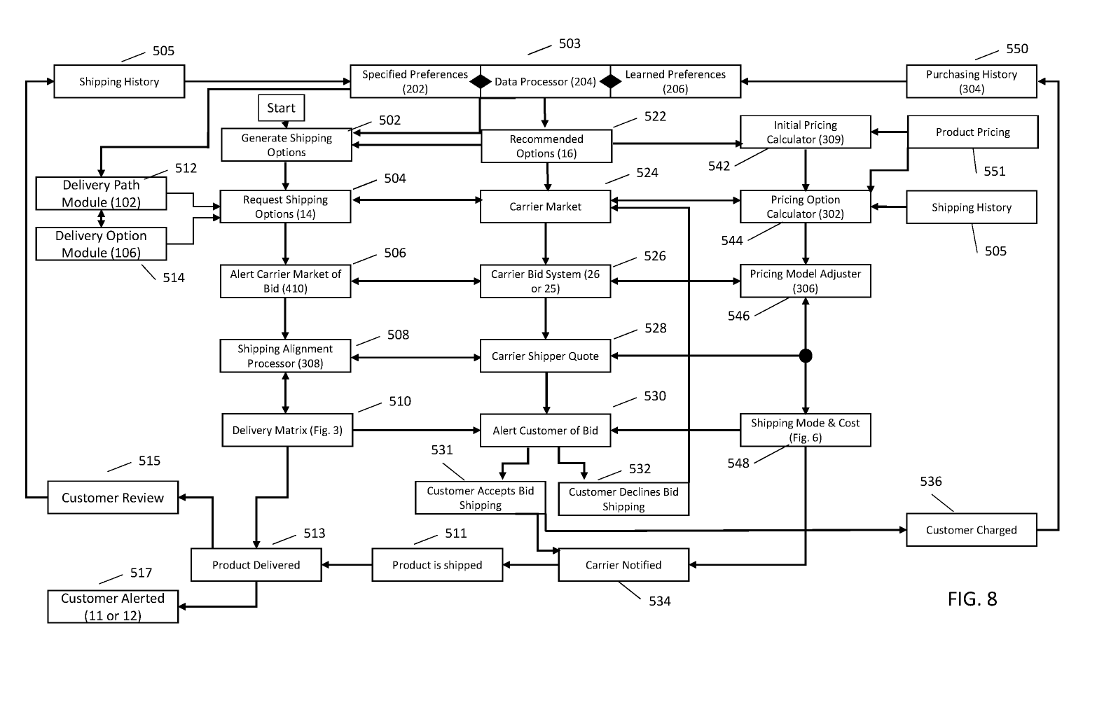

Accordingly, the SaaS system may include a cloud based matrix, or ecosystem of shipping options, shippers, and bids matrix. Referring to FIG. 8, this matrix aligns the original request by the customer (504, 512, 514, 502, 508) with the carrier market (524) which receives inputs from (548) and is then sent to the carrier bid system (526); Carrier shipper quote is then generated in 528; then, the customer is altered of a bid (530). platform which pre-generates an ecosystem of options. In accordance with some embodiments, ecosystem options may include one or more of carriers, speed of delivery, special handling or delivery instructions, buying methods, availability, and/or other assessment criteria, for example, described herein.

In some examples, the shipping options engine 14 may generate objects or elements that include carriers arranged by type, rating, classification, or other carrier-related feature. In some examples, the shipping options engine 14 may generate shipping options based on assessment criteria, including those described in examples above, and also including but not limited to carriers of items of interest for purchase arranged by delivery mode, for example, pickup, drive through, crowdsourcing delivery, autonomous vehicle delivery, or remote location of the customer. For example, the shipping options engine 14 may generate options for a customer that include the opportunity for the customer may wish to use a drive through window to purchase ice cream in one hour, or to have ice cream delivered to the customer's home in 5 days. In other examples, the shipping options engine 14 may generate objects or elements that include objects or elements including product care by category such as crushable or sensitive packages or other special considerations, temperature, weight, value, handling, security, assortment, care, and so on, time options such as speed duration and scheduling window, incentives, promotions, services, breaks, first time, groups, recurring events, and so on, quantities such as money, size, frequency, subscription (e.g., product/shipping), carrier services such as guarantees, certified, attended, wait time, care, temporary, calculated available shipping results based upon various factors. Factors may include one or more of the following:

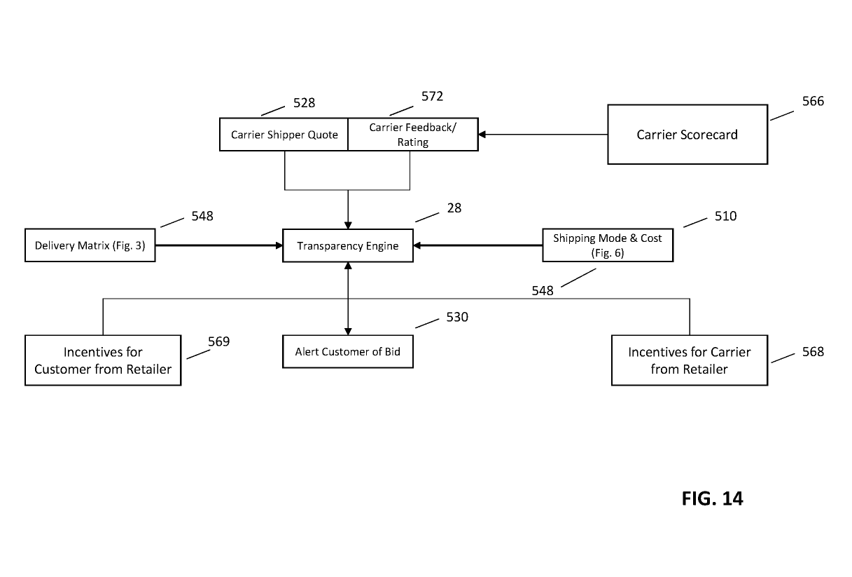

A carrier rating may be assessed as a subcategory (see, for example, FIG. 14 block 572). This information may be displayed within a carrier scorecard matrix in accordance with some embodiments, providing the customer with the rating feedback stores gathered for the assessment criteria. A carrier product handling classification may be assessed as a subcategory. A special classification may be provided where the carriers hold will be presented to the customer, providing them with their limitations for the types of packages they can deliver. Product Care and Assortment criteria where crush or other special considerations, temperature, weight, handling and security ma y be assessed as subcategories. Time options criteria wherein speed duration, schedule window, time of arrival and time of pickup may be assessed as subcategories. Convenience and Shipping Mode criteria where pickup, drive thru, delivery, remote and autonomous delivery may be assessed as subcategories. Incentive criteria where promotions, services, introductory special offers, group discounts, reoccurring and subscription may be assessed as subcategories. Quantity criteria where money, size, frequency, subscription for product and shipping may be assessed as subcategories. Carrier services where guarantees for delivery, certification of delivery, attended or unattended delivery and pickup, wait time, product care and temperature may be assessed as subcategories.

Other examples may include dynamic carrier alerts for shipping bids when customers order or carriers change. Examples of dynamic carrier and customer alerts may include one or more of change of carrier, time, cost, delivery time, delivery pickup, services, and/or bid , or a combination thereof. Data generated according to one or more of the assessment categories or subcategories can be processed by the shipping options engine 14.

The customer AI engine 16 tracks initial customer selections made with respect to shipping options, analyzes patterns regarding these selections. In doing so, the customer AI engine 16 can perform a subsequent shipping option selection on behalf of the customer based on the analyzed historical data. Shipping option selections that are tracked and analyzed by the customer AI engine 16 may include delivery mode, time duration, time slot, delivery location, type of care, cost, incentives, and products.

The pricing engine 22 calculates pricing options from shipping options provided either by the customer or generated by the customer AI engine 16. Pricing options may be displayed at the customer's device 12. In doing so, pricing for the options is also displayed,

The pricing engine 22 can record a history of pricing selected for future pricing options. The pricing engine 22 can calculate available incentives and promotions and adjust pricing model. The pricing module 22 can align shipping options with customer preferences for lowest shipping cost.

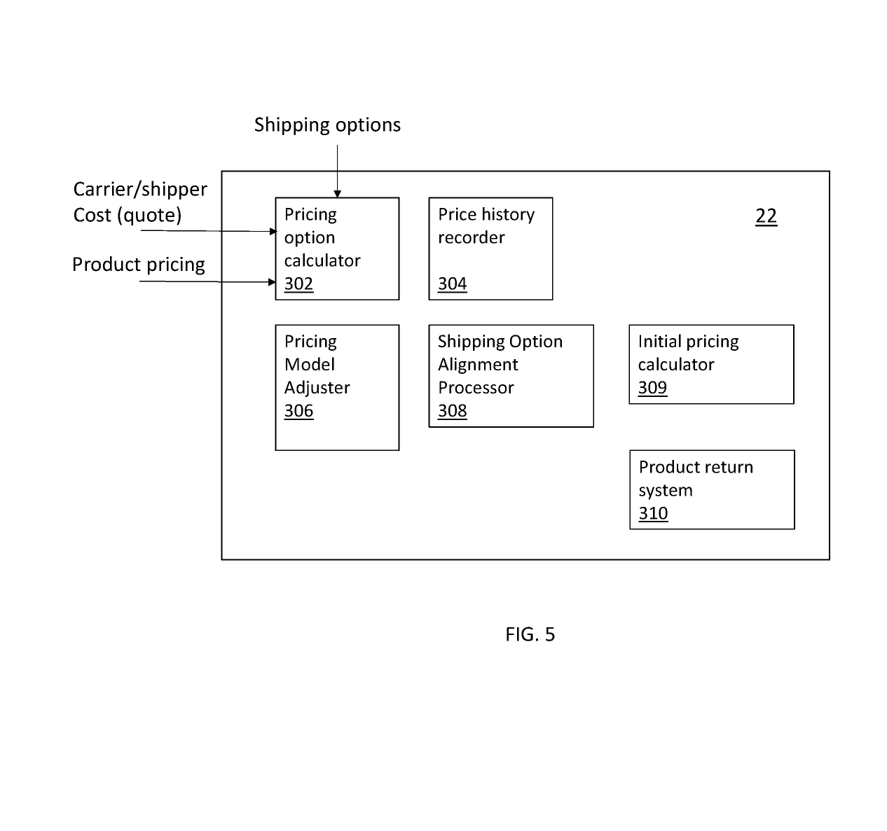

Inherent data produced by the customer AI engine 16 may be used for pricing. As described in FIG. 5, shipping options may be produced either by a customer or by the customer AI engine 16. For example, a pricing option calculator is computed from either a carrier or shipper cost quotation, product pricing, and/or shipping options inputted by the customer or AI engine 16.

The SaaS system auctioning engine 25 generates bids to the ecosystem market demand data and determines the best combination pricing. The auctioning engine 25 provides bidding data to the ecosystem of carriers. Carriers can also see their scores relating to on-time delivery and customer complaints. This information may be processed to create a ranking system, which compares carries based on the scores accrued. Examples of market demand data may include carrier demand based upon the bids placed by customers. For an example, if the auction engine 25 receives a slew of packages requiring special handling for cold, demand data will be generated indicating a high demand for carriers with cold handling capabilities. Examples of best combination pricing may include a combination of price and available carrier services in conjunction to the available bids.

The backend server 24 may include an auctioning engine 25 that may generate a score or related value that may be output to and received by the shipping bidder computer 26, which may be used by the carrier to see their score for on-time delivery, complaints, ranking with other comparable carriers or services, and so on. The backend auctioning engine 25 provides bidding data to the ecosystem of carriers. Carrier bidders can generate at a bidder computer 26 additional incentives, or change prices on the fly to offer customers better values, and so on. Carriers can set durations of time for special offers which may be for months or only available for certain hours of the day. Carriers can also see their scores relating to on-time delivery and customer complaints; this information can be used to create a ranking system, which compares carriers based on the scores accrued.

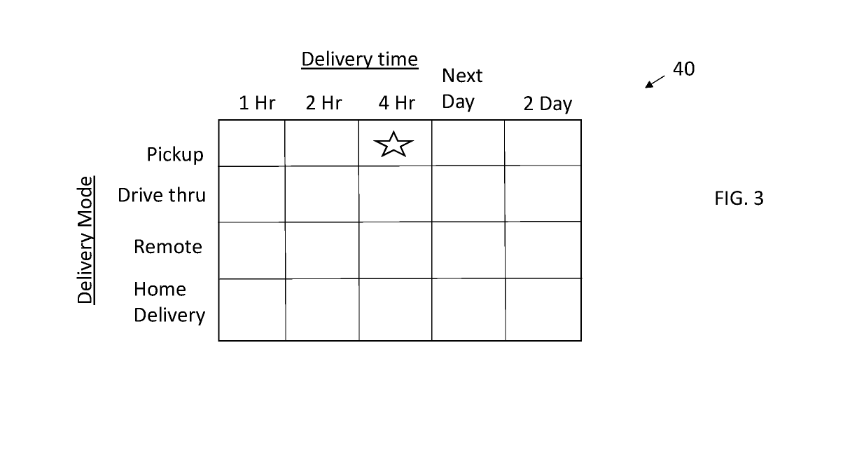

The customer can change on-the-fly the window for delivery and/ or pickup. When the customer requests this change, the customer will input their need. As demonstrated in FIG. 3, the customer selects a 4-hour pickup. Carriers will be notified of the change, and will have the option of bidding for this delivery through backend Server 24; which would then process this information in the market demand data. The backend auctioning engine provides bidding data to the ecosystem of carriers. Carriers can also see their scores relating to on-time delivery and customer complaints; this information will create a ranking system, which compares carries based on the scores accrued.

The customer electronic device 12 can be a smartphone, laptop computer, electronic notebook, or other computer. The customer electronic device 12 includes at least one processor and a storage device for executing a program for performing one or more of ordering products, requesting shipping options, setting customer preferences, and receiving and selecting shipping options. The customer electronic device 12 may include other components including a display, location finder such as a GPS device, scanning device, and so on.

The shipping bidder computer 26 is used by carrier for receiving and processing customer-specific shipping criteria and preferences, pricing, and bid alerts, and for presetting minimum and maximum incentives, adjusting shipping options for a customer 11, and processing package deliveries. For example, the shipping bidder computer 26 may process customer-specific shipping criteria, customer preferences, customer pricing, bidding alerts, and for presetting carrier incentives by minimum and maximum display carriers can also adjust shipping options for a customer. Carriers can also process package deliveries. In some embodiments, the shipping bidder computer 26 is part of the auctioning engine 25, and shares functionality at the backend server 25. The shipping bidder computer 26 may be used to process customer-specific shipping criteria, customer preferences, customer pricing, bidding alerts, and for presetting carrier incentives by minimum and maximum display carriers can also adjust shipping options for a customer; carriers can also process package deliveries.

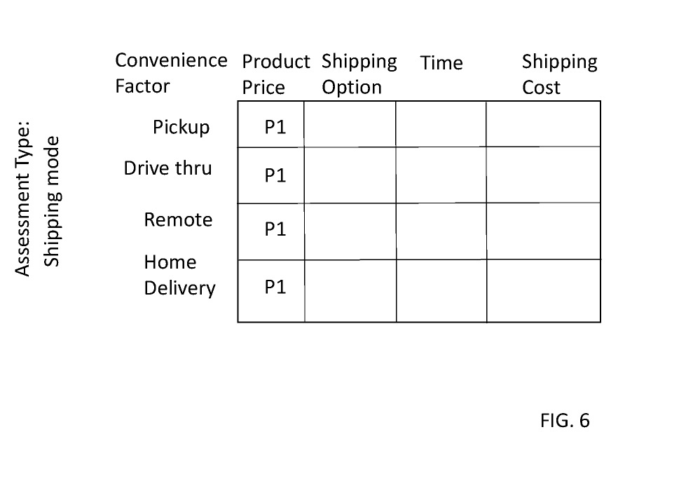

The transparency engine 28 generates data regarding the impact of a decision made by the customer 11. The transparency engine 28 may include a comparator that generates a comparison between shipping options and outputs the comparison result, for example, to the customer's mobile electronic device 12. A shipping options and savings matrix or table, for example, shown in FIG. 6, can organize the options according to price. A shipper may also access the transparency engine, for example, via shipper computer 20, to view transaction log data or the like produced by the transparency engine 28 to evaluate costs, incentives, and/or services that may be offered by the shipper. This allows the customer to see all potential options for their delivery with the costs associated. Thus, the transparency engine 28 may display contents of the matrix shown in FIG. 6.

The transparency engine 28 in some embodiments in generating a shipping options and savings matrix for display aligns customer's delivery pathways with the shipper's fulfillment of pathway's while providing transparency of the cost for the pathway selected, as well as other potential options. For example: if a pathway selected by a customer was to have the selected product shipped to the customer's home, the transparency engine 28 will not only show the costs associated with this, but will also show other potential options from the carrier with their associated costs such as: in-store pick up, pick-up at a locker, or a drop-off at work. In each of these situations, the transparency engine 28 will generate the costs associated with each, as well as demonstrate the savings from the customer's original chosen pathway. The shipping options and savings matrix is constructed and arranged to provide the foregoing, in particular, allowing a customer to view all potential options for the delivery with associated costs.

As carrier services are organized into classes, for example, classes including, but not limited to crowd sourcing, traditional delivery, autonomous delivery vehicle, shuttle point delivery with multiple carriers, whom break shipments from bulk to individual items, carriers by special handling, carriers by speed of delivery, and carriers by service. The classes are matched to customer expectations of convenience and delivery duration window. The normalizing engine 30 is constructed and arranged to group shipping offers from carriers to customers for cost comparison purposes. An example of this is demonstrated in the following: If a customer requires special handling with their package, the available carriers, whom have the special handling ability, are presented to the customer; also included in this presentation, are all other customer expectations, convenience requests and delivery window. So, as the system creates a list of carriers with the special handling criteria, it also accounts for all other customer requests. This may include the generation and application of processing-related rules to the SaaS process in some embodiments, including but not limited to executing more steps among the method steps of providing assessment criteria, generating, by the shipping options engine, a first set of delivery options constructed and arranged as a recommended customer shipping matrix from the received assessment criteria; receiving a customer request regarding a product order; receiving a request for at least one customer shipping preference; and presenting, in response to the customer request and the at least one customer shipping preference, a second set of delivery options and pricing corresponding to the delivery options.

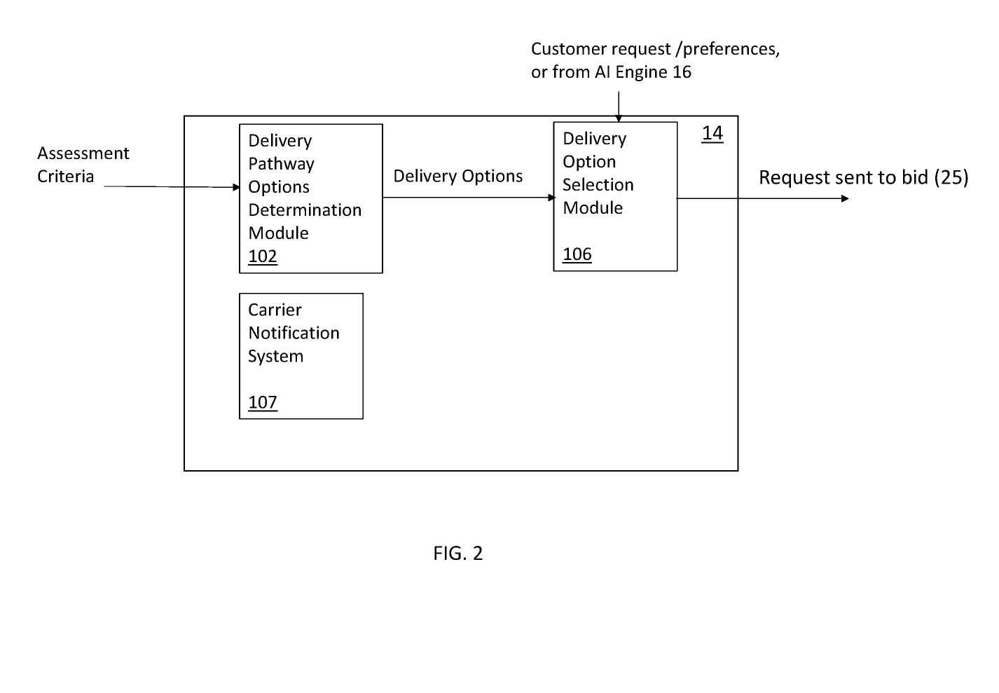

FIG. 2 is a block diagram of a shipping options engine 14, in accordance with some embodiments. The shipping options engine 14 can be implemented in the environment illustrated and described with respect to FIG. 1.

The shipping options engine 14 may include a delivery pathway options determination module 102, a delivery option selection module 106, and a customer notification system 107. Some or all of the functional components of the shipping options engine 14 can be co-located at a same hardware platform, or can be geographically separate at a separate location, and can communicate with each other via the network 16.

The delivery pathway options determination module 102 computes delivery options available for a customer 11 from a set of assessment criteria. The customer 11 may purchase one or more items from a brick-and-mortar store, online e-commerce website, distributor, or other supply chain source. In some embodiments, the delivery options include last mile delivery options. A matrix, or recommended customer delivery pathways matrix, may be formed from the customer AI data and/or from other learned shipping methods or recent learned inputs.

The assessment criteria may include one or more convenience factors, for example, delivery time of day, period of time, delivery location, delivery frequency, delivery conditions or special handling requirements, for example, hot or cold food delivery, and so on. Customer convenience factors may affect the price for shipping an item to the customer 11.

A delivery time convenience factor may include a duration window during which the customer 11 desires to receive an item. A high volume and/ or small duration window, for example, between 8-9 a.m. may be a popular time period, which can affect the price for shipping the item to the customer 11, since a high volume and/or small duration window may require additional or expensive resources from a carrier. The assessment criteria, i.e., duration window, hot food request, etc., may be stored at the data repository 18. Assessment criteria may be received from any number of different sources. In some embodiments, assessment criteria may be determined from a processing result of the customer AI engine 16 or shipping options engine 14.

The delivery pathway options determination module 102 may form one or more arrays, matrices, tables, or related structures the received assessment criteria, which is populated with delivery options determined from the assessment criteria, for example, one or more recommended shipping channels or last mile pathways.

Other delivery options may be selected for example by the customer AI engine 16 depending on a decision tree. A decision tree includes information received from customer inputs with regard to the delivery needs for a package. These include, but are not limited to the following: Time considerations, e.g., time of day, week, duration window, etc. , product considerations, e.g., cold, hot, fragile, bulk, crush, etc., Source location, e.g., home, office, Drop off, etc., target location, e.g., home, office, drop off, carrier, etc. , order size, e.g., bulk, etc., type of customer, e.g., individual, organization, subscription, etc., special Handling considerations, e.g., medical, hazardous materials, crush, fragile, stocking requirement, etc. From this information input by customers regarding their package, the ecosystem of available carriers, which can meet the needs of the customer's package needs, is generated. The pre-solved cloud matrix intelligently uses the inputs of the customer—decision tree—and analyzes this information with the available ecosystem carriers. In some embodiments, the pre-solved cloud matrix is similar to or the same as an ecosystem of shipping options, shippers and bids matrix described herein, where it may align the carrier market with customer needs for shipment. In other embodiments, where actual bids are not included, the matrix is similar to the shipper and customer alignment matrix described herein where no bids are included, and is generated prior to the ecosystem of shipping options, shippers and bids matrix.

The shipping options engine 14 may generate this matrix according to one or more different techniques, and be used to compute different combinations. The shipping options engine is generated from the inputted customer data regarding their package—decision tree—as well as the availability of carriers in the ecosystem. Since this information computes all available options matching both the customer's inputted information as well as the available carriers from the ecosystem, all combinations are displayed to the customer; this is how combinations are computed. The inputs for this information derive from the customers inputted data—decision tree—as well as the available carriers, whom match the information from the customer's decision tree. In regards to pricing, when this information is displayed to the customer, the pricing will also be displayed; this is mentioned in 2.3 from the disclosure; which says, “The system calculates costs for each of the available options.” Essentially, this would use the pricing engine 22.

For example, as shown in FIG. 3, the delivery pathway options determination module 102 can generate a shipping options combination matrix 40, also referred to as a delivery matrix or recommended customer shipping matrix, that includes possible combinations of shipping options, and more specifically, a set of objects or elements according to a customer delivery mode and delivery time. In FIG. 3, for example, a matrix of delivery time and delivery mode is produced. This matrix 40 is formed from inputs or learned data from the customer. A customer 11 may select, for example, using a mobile electronic device 12 shown in FIG. 1, from the shipping options combination matrix 40, a desire to retrieve a purchased item at a pickup window in 4 hours, shown by the selection star shown in FIG. 3. Carriers can submit a bid for this customer 11 according to the customer selection.

In some embodiments, the customer 11 can change on-the-fly the window for delivery and/or pickup. When the customer 11 requests this change, the customer will submit an input for need, for example, entered to a user interface of a computer. As demonstrated in FIG. 3, the customer selects a 4-hour pickup; carriers will be notified of the change for example, by the customer notification system 107, and will have the option of bidding for this delivery through the backend server 24, which would then process this information in the marked demand data, for example, described by way of example herein.

The customer can change on-the-fly the window for delivery and/or pickup. When the customer requests this change, the customer will input their need. As demonstrated in FIG. 3, the customer selects a 4-hour pickup, whereby carriers will be notified of the change, for example by the customer notification system 107, and will have the option of bidding for this delivery through the backend Server 24, which would then process this information in the market demand data. The backend auctioning engine 25 provides bidding data to the ecosystem of carriers. Carriers can also see their scores relating to on-time delivery and customer complaints; this information will create a ranking system, which compares carries based on the scores accrued.

The delivery option selection module 106 can compare the delivery options with customer preferences, and generate a set of available delivery options based on a match with customer preferences.

For example, information can be processed from the assessment criteria, such as rating where a carriers rating is assessed as a subcategory. This information will be displayed within the matrix, providing the customer with the rating feedback stores gathered for the assessment criteria. Other information may relate to a classification where a carriers' product handling classification is assessed as a subcategory. The special classifications the carriers hold will be presented to the customer, providing them with their limitations for the types of packages they can deliver. Other subcategories may include product care and assortment wherein crush, temperature, weight, handling and security, time options such as speed duration, schedule window, time of arrival and time of pickup, convenience and Shipping Mode such as pickup, drive thru, delivery, remote and autonomous delivery, incentives such as promotions, services, introductory special offers, group discounts, reoccurring and subscription, quantities such as money, size, frequency, subscription for product and shipping; and carrier services such as guarantees for delivery, certification of delivery, attended or unattended delivery and pickup, wait time, product care and temperature. The delivery options may subsequently be computed by the delivery options selection module 106, which processes information from the customer's requests and preferences. Delivery options may also, or in addition, be computed from customer AI Engine 16. A request may be sent to the backend server 24 for relevant data to assist with the determination of options.

When the foregoing information is displayed, for example, for viewing at a computer display by the customer, pricing may also be displayed. The pricing engine 22 may calculate costs for each of the available options. In some embodiments, the pricing engine 22 is part of the shipping options engine 14, and a pricing matrix may be generated therefrom.

The generated matrix of options, more specifically, shipping options based upon an established match on customer preferences, are output from the delivery pathway options determination module 102 to the auctioning engine 25, which alerts interested carriers of the bidding opportunity. Each option in the matrix 40 may have a different price, except for an option marked N/A, for example, where the option is not offered.

In some embodiments, the options may be based on a decision tree, for example, described above. In other embodiments, the decision tree or AI may select one or more options.

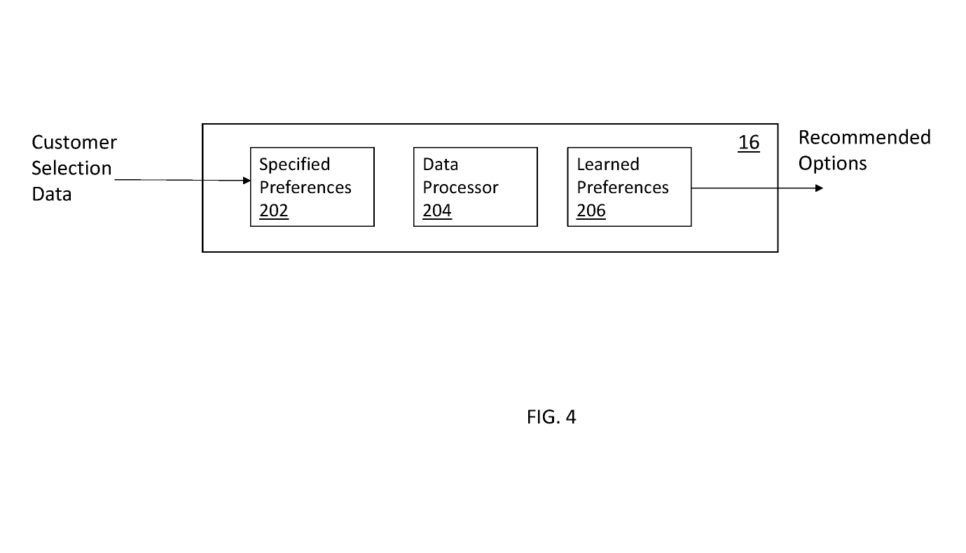

FIG. 4 is a block diagram of a customer artificial intelligence (AI) engine 16, in accordance with some embodiments. The customer AI engine 16 can be implemented in the environment illustrated and described with respect to FIG. 1.

The customer AI engine 16 may include a preference tracking module 202, a data processor 204, and a learned preference generator 206. Some or all of the functional components of the customer AI engine 16 can be co-located at a same hardware platform, or can be geographically separate at a separate location, and can communicate with each other via the network 16.

The customer-specified preferences received by the preference tracking module 202 may be the same as the customer preferences provided to the delivery option selection module 106 of the shipping options engine 14 described with reference to FIG. 2. The preference tracking module 202 may track shipping options selected by the customer 11. For example, the preference tracking module 202 can track when the customer selects which shipping module, e.g., pickup, drive through, home/office delivery, and so on, which method, e.g., Fedex™, United Postal Service (UPS), crowdsourcing, and so on, which duration of time, which time slot, which delivery locations, what type of care, e.g., attended, unattended, what cost and incentives, what products, or a combination thereof. Other selection data may include time of delivery, duration, product, care, convenience, and so on. This information may be stored at data repository 18, and processed. In particular, this information is captured by the customer AI engine 16 to provide an intelligent suggestive based on the learned inputted data from the customer, which then the AI engine 16 produces recommended options. The foregoing process may be derived from the following information, such as but not limited to time, product considerations, source location, target location, order size, type of customer, special handling instructions, preferred carrier source, such as traditional, crowdsourcing, autonomous, shuttle point delivery, price, or a combination thereof

The customer preferences received and processed by the preference tracking module 202 may be used by the data processor 204 to analyze the customer preferences for determining patterns and/or to determine other analytics. For example, as a customer selects options, for example, one or more options mentioned above, patterns arise from these selections. The data processor 204 may receive external data such as customer learned preferences, inputted preferences, ratings issued to carrier services, and so on.

The AI engine 16 may initially require customer selection data in order to generate a recommended option. However, over time, as data is collected, the learned preference generator 206 can generate selections on behalf of the customer, and output recommendation options based on the learned preference results (also referred to as learned customer preference requests) to the delivery option selection module 106 of FIG. 2 instead of customer preference requests provided from the customer electronic device 12. However, the customer 11 may override options generated by the learned preference generator 206, opting to provide customer preference requests instead of learned preference results to the shipping options engine 14.

FIG. 5 is a block diagram of a pricing engine 22, in accordance with some embodiments. The pricing engine 22 can be implemented in the environment illustrated and described with respect to FIG. 1

The pricing engine 22 may include a pricing option calculator 302, a purchase history recorder 304, a pricing model adjuster 306, and a shipping option alignment processor 308, an initial pricing calculator 309, and/or product return system 310. Some or all of the functional components of the pricing engine 22 can be co-located at a same hardware platform, or can be geographically separate at a separate location, and can communicate with each other via the network 16.

The pricing option calculator 302 may calculate a price for corresponding shipping options, for example, shipping options generated by the shipping options engine 14, and/or by recommended options generated by the AI engine 16. Pricing option calculator 302 receives information from either the customer and/or the AI Engine 16. The data received from one or both of these two sources is processed by the pricing option calculator 302. The pricing option calculator 302 will also receive information from a carrier/shipper cost or quote, and the product pricing.

In some embodiments, a price may be adjusted depending on the various inputs received. For instance, if a bulk shipment is inputted by the customer. In another example, if the market demand data determines the item being shipped by the customer has limited carrier options at this time, the pricing model adjuster 306 will compensate for this. The pricing engine 22 may also address and provide pricing adjusted for discounts, incentives, and so on, for example, described herein.

The pricing option calculator 302 may receive a product price from an external data source, for example, a store department storage device, and determine whether the price changes or is adjusted based on shipping options, for example, performed by the adjuster 306.

The purchase history recorder 304 records a history of pricing selected, which can be used for future pricing options. Referring again to FIG. 4, a customer's specified preferences 202 is processed by the data processor 204, and gathered and learned in customer AI engine 16. customer AI engine 16 in turn stores the learned preferences 204 into the data repository 18. A purchase history recorder 304 may be used for the customer to review past purchases, as well as to assist customer AI engine 16 with the foregoing in an effort to suggest options based on the previous gathered information from the customer.

The initial pricing calculator 309 can receive inputs from the AI engine 16 and product prices stored at a database and generate a result that can be used by the pricing option calculator 302, which may combine the initial pricing result with shipping history data, and/or carrier data to determine pricing options. Shipping history data can include customer purchase and/or delivery history information.

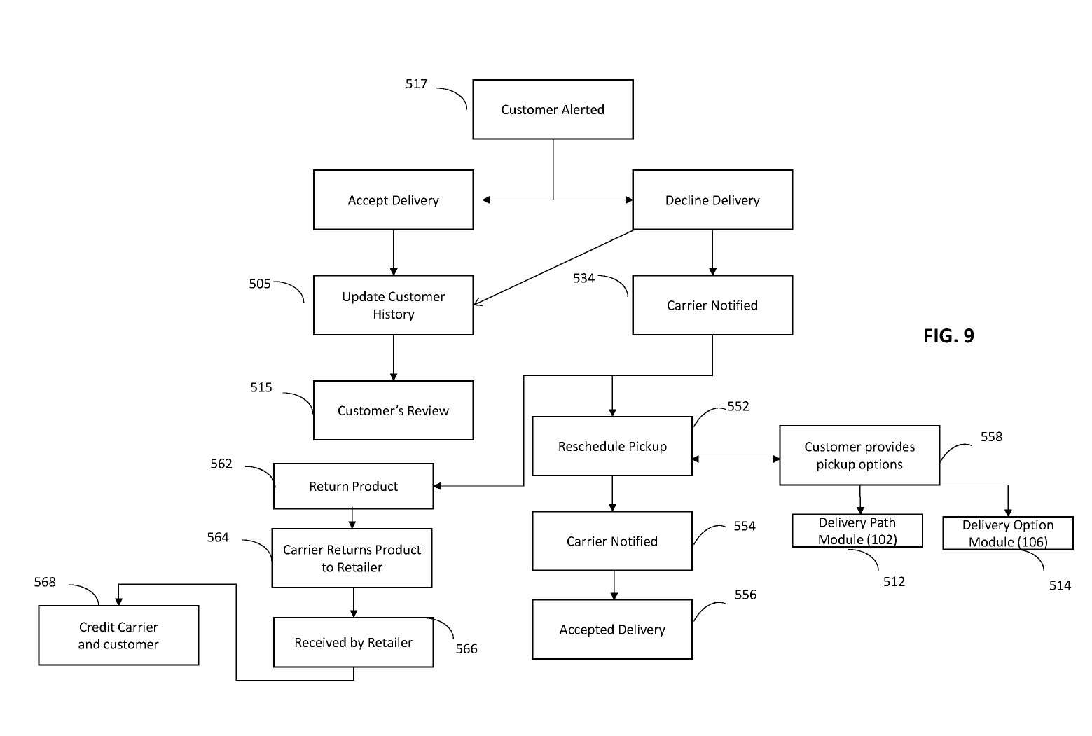

The product return system 310 may perform some or all of the process steps described in FIG. 9, in particular, rescheduling product pickup, notifications, outputting return credit data, updating customer history, and so on.

In FIG. 5, at the top of the figure lists the inputs for the pricing option calculator 302. However, these inputs do have an effect on purchase history recorder 304. Inputs listed at the top of FIG. 5 are customer shipping options from either the customer inputs or the AI engine 16; this should also include the previous purchases and preferences recorded into the data repository 18.

The pricing model adjuster 306 calculates available incentives and promotions and adjusts the pricing model. In sum, a price may be adjusted depending on the various inputs received. For instance, if a bulk shipment is inputted by the customer; or another example, if the market demand data determines the item being shipped by the customer has limited carrier options at this time, the pricing model adjuster module 306 will compensate for this. Pricing option calculator 302 computes a combination of carrier/shipper cost quote, product pricing, or shipping options inputted by the customer or AI engine 16.

The shipping option alignment processor 308 aligns shipping options with customer preferences for identifying shipping options for the customer (shown for example in the table illustrated in FIG. 6, also referred to as a shipping options and savings matrix). The shipping option alignment processor 308 provides a normalized demonstration of all competitive shipping options and what the ecosystem of carriers provides. For example, crowdsourcing options would be provided to the customer, which parallel with the customer's choices, including: cost, time, services, special handling, etc. The table shown in FIG. 6 can identify item delivery paths according to price in view of convenience factors. In some embodiments, the table shown in FIG. 6 identifies the shipping options available with the costs associates as well as the time windows available. The shipping option alignment processor 308 may generate a shipper and customer alignment matrix that aligns potential shippers with a customer's criterion without the associated costs.

The carriers can also input automated incentives for first time buyers, reoccurring buyers, seasonal specials, etc.; these options would be presented to the customer; carriers can also display special features they offer.

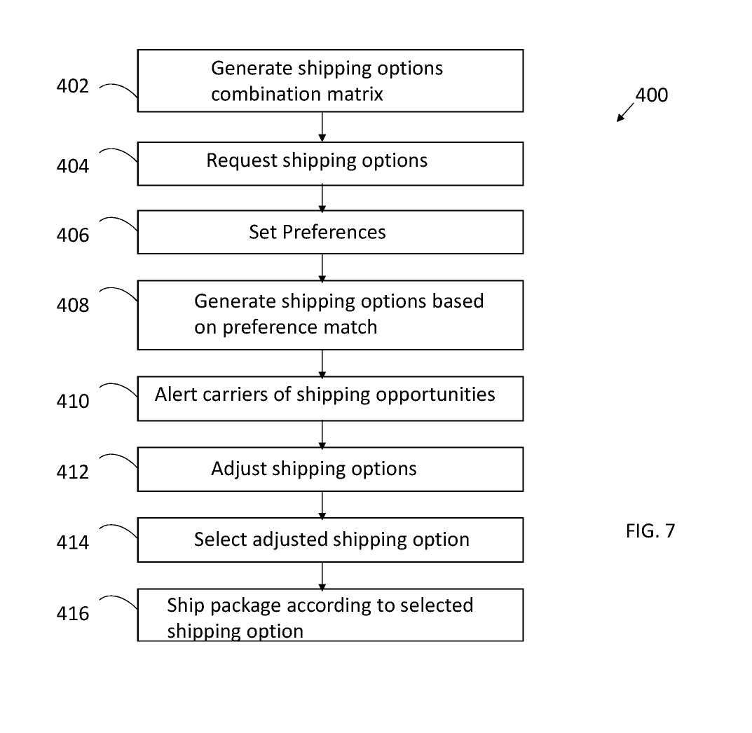

FIG. 7 is a flowchart of a method 400 for determining shipping options, in accordance with some embodiments. In describing the method, reference is made to elements of FIGS. 1-6. Some or all of the method 400 can be governed by instructions that are stored in a memory of, and executed by a processor of, the SaaS system, mobile electronic device, and/or other hardware described in FIG. 1.

At block 402, at least one shipping options combination matrix is generated. For example, a matrix may be generated by a shipping options engine 14 that includes possible combinations of shipping options, and more specifically, the includes options based on customer delivery mode and delivery time. The customer AI engine 16 and/or pricing engine 212 may also contribute to the generation of shipping options, as described herein.

At block 404, a customer 11 may order one or more products. In doing so, the customer may request shipping options for the ordered products.

At block 406, preferences may be set by the customer 11. For example, the customer 11 may request a particular time, product factor, location, order size, or special handling instructions.

At block 408, the shipping options system 14 may generate available shipping options based on a match between the customer preferences and the learned preferences, which are input, for example, by the customer. Then, they are stored within the data repository 18. Then, they are learned and processed within the customer AI engine 16. All of this information is stored as a baseline of information, assisting the AI engine 16 in generating available shipping options based on previously inputted and learned information.

At block 410, the auctioning engine 25 can alert interested carriers of a bidding opportunity based upon an established match on customer preferences provided from the shipping options engine 14. The system may provide bidding alerts in a situation where the customer has changed an aspect of their delivery; then, the delivery is sent back to the bidding system, where carriers can bid on the delivery; so, after a carrier has declared a bid for the delivery, the customer is alerted of this change. This provides the customer with awareness their product has a new carrier for delivery; also, the customer could at this time review the carrier's criteria, ensuring their delivery is successfully completed.

At block 412, the bidding carrier or carriers preset a minimum, maximum, incentives, and adjust shipping options for the customer 11. The shipping bidder computer 26 is used to process customer-specific shipping criteria, customer preferences, customer pricing, bidding alerts, and for presetting carrier incentives by minimum and maximum display carriers can also adjust shipping options for a customer; carriers can also process package deliveries.

Once all of the available options are identified, the cost of the options are presented to the customer 11. At block 414, the customer 11 selects a shipping option among the selected shipping options. In some embodiments, once an option is selected, the total shipping cost can be presented to the customer 11, for example, displayed at a mobile electronic device 12, along with the corresponding incentives, guarantees, promotions, and so on. The selection indicates the full cost and savings of the shipping, as well as delivery information, such as delivery location, type of delivery (e.g., attended or unattended), and so on. The customer 11 may change the factors establishing the options, whereby the system automatically recalculates the cost per option.

At block 416, the customer's purchased item is shipped according to the selected option. Option and shipping details may be stored at the data repository 18 for future use, for example, by the customer AI engine 16.

FIG. 8 is a flow diagram of a shipping as a service (SaaS) process, in accordance with some embodiments. In describing the process, reference is made to elements of FIGS. 1-7.

At block 502, shipping options are generated, for example, as described herein with respect to method steps 402 and 408. In doing so, a matrix may be generated as described herein. This matrix may be referred to as a recommended customer shipping matrix, whereby initially computer shipping options provided to the customer from their learned data or recent inputs. An input (block 522) from the customer AI engine 16 (block 503) may be provided to generate shipping options, which may be output and received for consideration as shipping options at block 502. At block 542 the initial pricing calculator 309 may receive product pricing (block 551) and recommended options (block 522) to generate the result. The pricing option calculator 302 at block 544 may calculate a price for corresponding shipping options (block 554), for example, shipping options generated by the shipping options engine 14, and/or by recommended options generated by the AI engine 16. Pricing option calculator 302 at block 544 receives information from either the customer and/or the AI Engine 16. The data received from one or both of these two sources is processed by the pricing option calculator 302. The pricing option calculator 302 may also receive information from a carrier/ shipper cost or quote, and the product pricing.

The customer AI engine 16 (block 503) may determine or recommend shipping options or factors (block 522) for considering shipping options based on shipping history data (block 505) and/or from purchase history data (block 550). Shipping option details may be based on the analyzed historical data.

At block 504, shipping options are requested, for example, at the shipping options engine 14. The delivery pathway options determination module 102 (block 512) and a delivery option selection module 106 (block 514) may provide data for determining a result, i.e., relevant shipping options.

In some embodiments, customer preference data may be output from block 503 to going directly into the shipping options engine at block 502. Information processed into the customer's AI and profile may be presented as recommended options, which can also generate shipping options based on the customer profile/AI.

At block 506, a carrier market (524) is alerted of a bid based on the shipping options generated in block 504 and/or recommended options (522). The carrier market (524) includes one or more candidates who can deliver requested items to a desired destination. At block 526, the carrier bid system computer 26 and/or auctioning engine 25 may receive the bid alert. The carrier bid system computer 26 and/or auctioning engine 25 may also receive an input from the pricing model adjuster 306 (see block 546). As described herein, the pricing model adjuster 306 may adjust a price depending on the various inputs received. For instance, if a bulk shipment is inputted by the customer; or another example, if the market demand data determines the item being shipped by the customer has limited carrier options at this time, the pricing model adjuster 306 will compensate for this.

At block 508, the shipping option alignment processor 308 aligns shipping options with customer preferences for identifying shipping options for the customer (shown for example in the table illustrated in FIG. 6). A bid response, or quote (block 528), can be generated by the carrier bid system computer 26 and/or auctioning engine 25 and output to the shipping option alignment processor 308 for aligning the shipping options.

At block 510, a delivery matrix is generated from an output of the shipping option alignment processor 308. At block 530, a bid alert is generated and output to the customer making the shipping request, for example, sent as an email message, text message, live phone call, and so on. The bid alert (530) may be generated by the delivery matrix (block 510), e.g., illustrated in FIG. 3 and a matrix or table (block 548) that provides delivery modes according to price, e.g., illustrated in FIG. 6. . For example, an ecosystem of shipping options, shippers and bids matrix may include the shipper's fulfillment for the customer's delivery/ shipping requests, for example, the shipper's options aligning with the customer's delivery request.

At block 531, the customer accepts the bid offer, whereby the selected carrier is notified (block 534), and the customer is charged (block 536) for the shipping fee agreed upon in the bid. In some embodiments, the carrier is notified by the notification system 107. When the customer is charged (block 536), the shipping purchase transaction may be stored at the purchase history recorder 304 (block 550). At block 511, the product is shipped according to the selected options, and at block 513 is delivered by the selected carrier. The customer may have an opportunity to provide a review (block 515). The customer may also be notified of the delivery (block 515). The process may proceed to block 505, where information on the shipment may be stored for historical purposes, which may be used by the AI engine 16 for determine subsequent shipping options.

Returning to block 530, another option is for the customer to decline the bid offer at block 532, whereby the process returns to block 524, where another carrier alerted of the bid may be considered, or the customer may elect not to proceed with bidding process.

Referring to FIGS. 8 and 9, at block 517, the customer may be alerted, for example, receive an alert on the customer's electronic device 12, e.g., smartphone, of a product delivery. The electronic device 12 may execute an application that performs elements of method or process steps illustrated in FIGS. 8 and 9. The application may present to a user interface executed at the electronic device a set of options, including the option to accept or decline delivery. Regardless of whether delivery is accepted or declined, the method at FIG. 9 proceeds to block 505, where the customer history may be updated. Referring again to FIG. 9, the method proceeds from block 505 to block 515, where the customer may have an opportunity to provide a review.

If at block 517, the customer declines delivery, for example, by selecting an icon or the like on the device display, the method proceeds to block 534 where the carrier is notified.

At block 552, pickup is rescheduled. At block 554, the carrier is notified. At block 556, delivery is accepted.

Returning to block 552, in response to pick up rescheduling, the method may proceed to block 558, where the customer provides pickup options, e.g., provided via electronic device 12. Shipping/pickup options may be requested, for example, at the shipping options engine 14. The delivery pathway options determination module 102 (block 512) and a delivery option selection module 106 (block 514) may provide data for determining a result, i.e., relevant options.

Returning to block 534, in response to the carrier being notified, the delivered product may be returned (block 562) to the carrier. At block 564, the carrier returns the product to the store or other place of origin. At block 566, the returned product is received. At block 568, the carrier and/or customer receive a credit for the returned product. The product return system 310 may initiate this step, or communicate with other system components to initiate payment returns.

Referring again to FIGS. 3-8, the shipping mode options table may be generated from the following modules: recommended options and customer AI illustrated with respect to blocks 503 and 522 of the customer AI engine 16; the initial pricing calculator 309, the pricing option calculator 302, which at block 544 receives and sends information to the carrier market 524, the pricing model adjuster 306, which at block 546 receives information from the carrier bid system 25, 26, which in turn at block 526 provides an input to the pricing model adjuster 306, the carrier market 524, which at block 524 exchanges data with the pricing option calculator 302, and the customer shipping options 502 and 504. Accordingly, the table shown in FIG. 6, also referred to as a shipping mode and cost matrix, identifies the shipping options available with the costs associates as well as the time windows available.

Referring again to FIG. 3, a delivery matrix 40 may be generated from the following modules: shipping options engine 14 which at block 502 generates shipping options, and processes requested shipping options received from the delivery path module 102 at block 512 and delivery option module 106 at block 514, and information parsed to the customer from the carrier market bid (see step 410 of FIG. 7). The foregoing may be aligned at the shipping option alignment processor 308 at block 508, then output as the delivery matrix 40. Accordingly, the delivery matrix 40 includes delivery options available to the customer aligned with what is available from the customers, as well as the customer's inputted or learned preferences.

Referring again to the transparency engine 28, the transparency engine 28 receives the following inputs from the following modules: information from the delivery matrix 40, information from the shipping mode and cost matrix for example shown in FIG. 6, a carrier shipper quote generated at block 528 received from the bid system at block 526, and/or a carrier feedback rating derived from the carrier's scorecard. Accordingly, the transparency engine 28 can provide information regarding: all available costs, shipping options, convenience options, delivery duration and windows, carrier feedback, carrier services, carrier qualifications, and incentives for carrier as well as customer. This can be demonstrated in a grid, chart, matrix, or some other visual element to show this information to the customer.

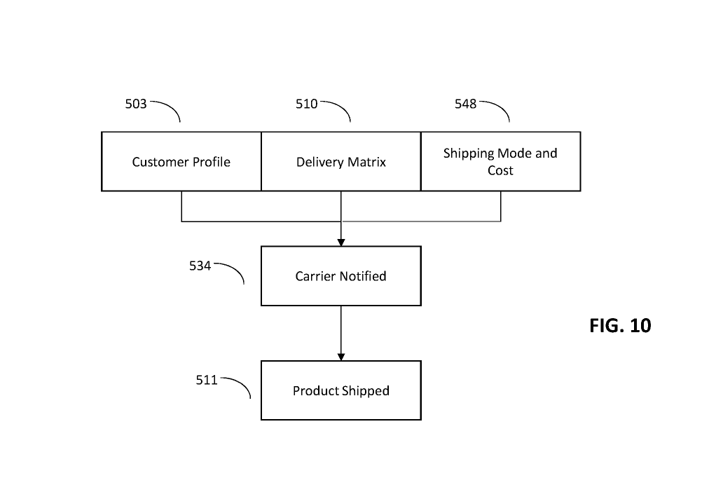

Referring to FIG. 10, details are provided of an embodiment where a carrier is notified that the carrier has been selected during a bidding process to deliver store items to a customer. The carrier is notified (block 534) in response to the customer notification system 107 receiving three different inputs, including but not limited to customer profile (block 503), a delivery matrix (block 510), and a shipping mode and cost (block 548). After the carrier is notified, the product is shipped (block 511).

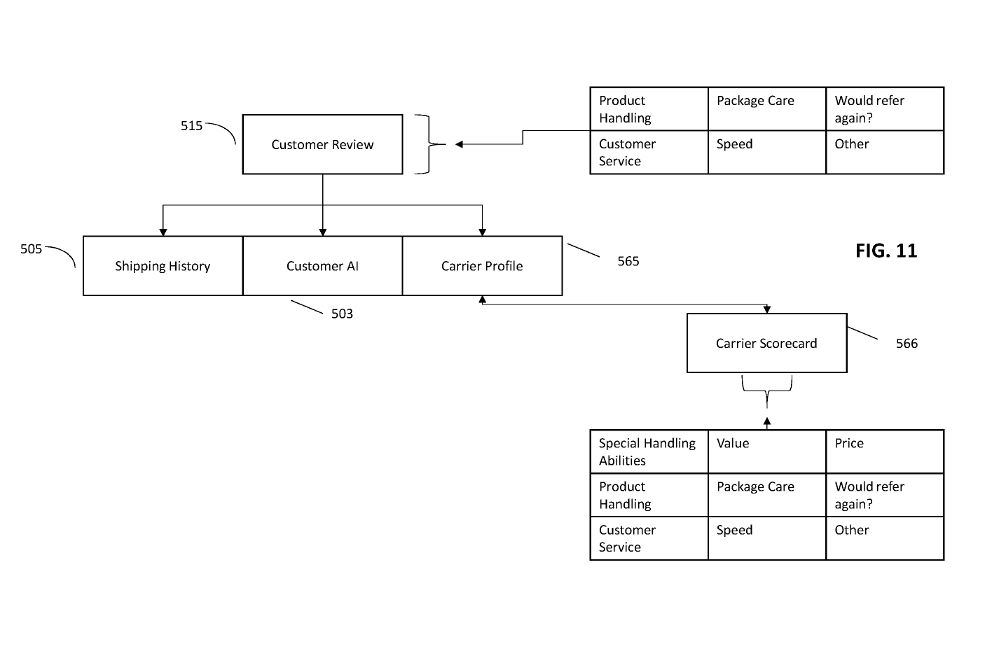

Referring to FIG. 11, the shipper computer 20 may include a carrier engine system and profile. Data from a customer review (block 515) may be provided as part of shipping history (block 505), customer AI (block 503), and carrier profile (block 565). Other customer review data may include but not be limited to product handling, package care, referral questions, customer service ratings, speed of delivery, and so on. The carrier profile (block 565) may include a scorecard (block 566), which provides a rating or ranking of various aspects of the delivery, such as special handling, value, price, product handling, package care, referral, customer service, speed, and so on.

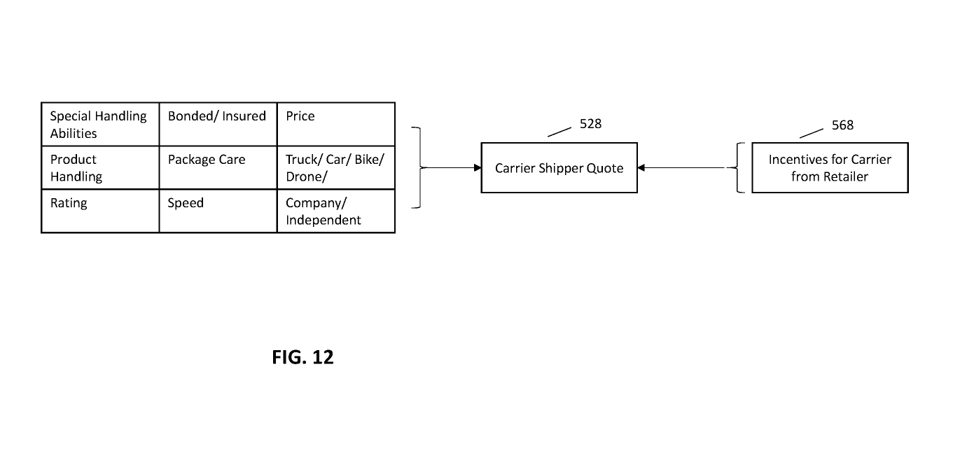

FIG. 12 illustrates details of the bid response or quote (block 528), including a carrier shipper quotation breakdown and incentives for the carrier from the retailer offering the product for sale to be delivered to a customer. The bid response, or quote (block 528), can be generated by the carrier bid system computer 26 and/or auctioning engine 25. In doing so, the carrier can receive incentives to promote carrier loyalty to the network by the retailer assuming some of the cost as well as provide fuller loads and better rates. Incentives (block 568) can be provided, whereby the retailer may offset or assume some of the cost of the shipping quote to provide incentive for preferred carriers. This may be produced by an algorithm which uses one or more inputs in determining the incentive, including but not limited to special handling abilities, carrier market demand, bonded or insured, carrier rating, product handling, and so on. Accordingly, FIG. 12 illustrates that carrier bids and benefits may be simplified. Carrier bids may include cost, timeliness, or special handling capabilities. Benefits may include fuller delivery loads, especially on return trips.

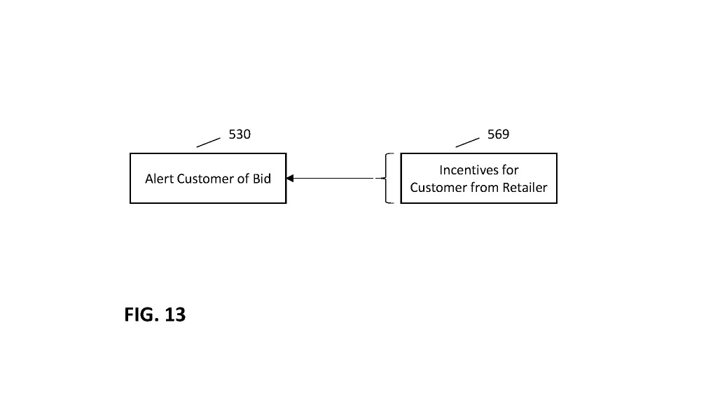

Referring to FIG. 13, and referring again to block 530, a customer may be alerted of a bid. At block 569, the customer may receive incentives. The retailer may offset or assume some of the cost of the shipping quote to provide incentive for customers. This may be produced by an algorithm which uses inputs in determining the incentive, including but not limited to: customer loyalty, carrier market demand data, carrier rating's, delivery window, promotional offers, coupons, and so on.

As described above, the transparency engine 28 generates data regarding the impact of a decision made by the customer 11. FIG. 14 includes additional details on the transparency engine 28. The transparency engine 28 may provide transaction log data so that costs, carrier and customer incentives, and/or services that may be offered by the shipper may be evaluated. Other data may relate to convenience, delivery duration and window, carrier feedback (block 572), service, and qualifications.

For customers, this feature may be analogous to a rental car service. Here, criteria is set, such as low price, but allows customers to override lowest price to choose low-enough based on other factors such as familiarity and trust from their preferred brand.

Referring to FIG. 15, the carrier market (524) can be fulfilled internally with preferred carriers, for example, carriers preferred by the customer, or alternatively, can be crowdsourced. FIG. 15 illustrates a breakdown of a carrier market in accordance with some embodiments.

As described herein, the carrier market (524) may receive a bid alert based on the generated shipping options or recommended options. The carrier market (524) may submit a customer's bid with their specified preferences or learned preferences to the carrier market. The carrier market (524) submits this information the carrier market; which aligns the information submitted from the customer to the available carriers.

In FIG. 15, the carrier market will include but is not limited to the following information when interacting with the customer's bid submission: carrier rating, cost, certifications, insurance/bond, customer delivery pathway (see block 512), pricing options calculator (see block 524), insurance/bond, product handling, shipping options (see block 504), incentives for customer, pricing model adjuster (see block 546), product installation and setup needs, delivery matrix (see block 510), market demand, vehicle required, incentives for carrier, customer loyalty, special handlings, customer delivery window, location (see block 514), and customer profile.

Essentially, the Carrier Market includes all information from the customer (504, 502, 503, 522) and sends this information to the carrier market (524)/ or alert carrier market of bid (506); which 524 includes all information I mentioned in the above; which then computes possible options and sends these to 526—Carrier Bid System; which then produces a carrier shipper quote—528; which then alerts the customer of a bid—530, where the customer can either accept the bid (530) or decline the bid (532); which if the bid was declined, the entire cycle would be restarted.

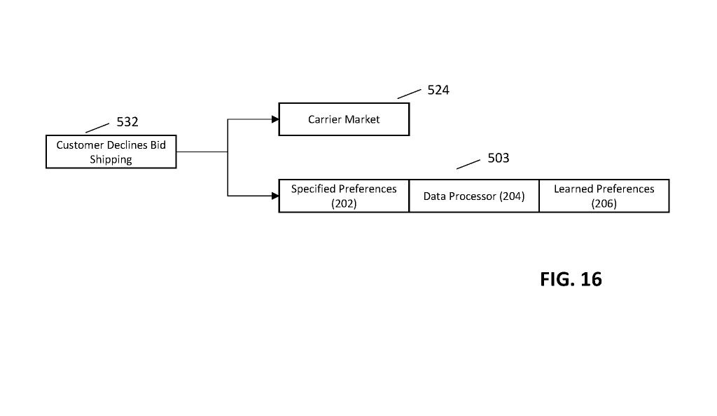

Referring to FIG. 16, a customer may decline a bid (block 532). When the customer declines the bid, the system will gather information on why the bid was declined. This information can be stored into the customer's profile, for example, at the carrier market 524, and processed through the AI engine 16 so it can better anticipate the customer's needs.

As will be appreciated by one skilled in the art, aspects of the inventive concepts may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

While the invention has been shown and described with reference to specific preferred embodiments, it should be understood by those skilled in the art that various changes in form and detail may be made therein without departing from the spirit and scope of the invention as defined by the following claims.

The foregoing and other features and advantages of the invention will be apparent to those of ordinary skill in the art from the following more particular description of the invention and the accompanying drawings.

The foregoing and other features and advantages of the invention will be apparent to those of ordinary skill in the art from the following more particular description of the invention and the accompanying drawings.

What is claimed is:

1. A shipping options system, comprising:
a shipping options engine that generates a plurality of store item delivery options in response to a set of assessment criteria and generates a bid request in response to the delivery options; and
an auctioning engine that receives the bid request from the shipping options engine, and submits the bid request to at least one carrier according to a comparison between a carrier score and capabilities of the carrier to satisfy the bid request.

2. The shipping options system of claim 1, further comprising a customer artificial intelligence (AI) engine that generates and outputs a recommended option to the shipping options engine, and wherein the bid request is generated in response to the recommended option.

3. The shipping options system of claim 2, wherein the customer AI engine monitors customer shipping preferences, determines analytics from the customer shipping preferences, and generates the recommended option in response to a determined analytic result.

4. The shipping options system of claim 2, wherein the customer AI engine comprises:
a preference tracking module that processes shipping history data and analyzes customer shipping preferences for determining analytic data;
a learned preference generator that processes purchase history data; and
a data processor that outputs the recommended option in response to the processed purchase history data and shipping history data.

5. The shipping options system of claim 2, wherein the shipping options engine selects either the recommended option or a customer preference request for generating the store item delivery options.

6. The shipping options system of claim 5, wherein data processed at the customer AI engine is presented as the recommended option, and wherein the shipping options engine generates the store item delivery options in response to an output of the customer AI engine.

7. The shipping options system of claim 1, wherein the shipping options engine comprises:
a delivery pathway options determination module that computes the delivery options in response to the set of assessment criteria; and
a delivery option selection module that selects for a bid request at least one delivery option from the plurality of delivery options.

8. The shipping options system of claim 7, wherein the delivery pathway options determination module generates at least one recommended customer delivery pathways matrix from the assessment criteria, and populates the recommended customer delivery pathways matrix with combinations of the delivery options.

9. The shipping options system of claim 7, further comprising:
a shipping option alignment processor that aligns the shipping options with contents of a shipper and customer alignment matrix for identifying customer-preferred shipping options.

10. The shipping options system of claim 8, further comprising a transparency engine that receives a combination of the data of a shipping options and savings matrix, information from shipping mode and cost matrix data, a carrier shipper quote, and a carrier feedback rating, and generates as an output information regarding: all available costs, shipping options, convenience options, delivery duration and windows, carrier feedback, carrier services, carrier qualifications, and incentives.

11. The shipping options system of claim 1, further comprising a pricing engine that calculates pricing options corresponding to the plurality of store item delivery options.

12. The shipping options system of claim 11, wherein the pricing engine comprises a pricing model adjuster that changes shipping prices for the delivery options in response to data related to the delivery options.

13. The shipping options system of claim 1, further comprising a product returns system for processing a product return in response to a carrier notification.

14. The shipping options system of claim 1, wherein the auctioning engine generates the carrier score from a carrier profile.

15. The shipping options system of claim 1, wherein the assessment criteria include convenience factors, including at least one of time of day, location, frequency, hot, cold, or special handling, and wherein pricing increases for the convenience factors.

16. A method for shipping, comprising:
providing two or more assessment criteria;
generating, by a shipping options engine, a first set of delivery options constructed and arranged as a recommended customer shipping matrix from the received assessment criteria;
receiving a customer request regarding a product order;
receiving a request for at least one customer shipping preference; and
presenting, in response to the customer request and the at least one customer shipping preference, a second set of delivery options and pricing corresponding to the delivery options.

17. The method of claim 16, further comprising:
receiving by a customer artificial intelligence engine shipping history data and purchasing history data that include learned and gather information; and
generating by the customer artificial intelligence engine a recommended shipping option of the first set of delivery options.

18. The method of claim 17, wherein the customer artificial intelligence engine collects data over time, and generates a recommended shipping option on behalf of the customer and instead of a customer directed shipping option.

19. The method of claim 16, wherein the assessment criteria are provided for computing the delivery options, and wherein the assessment criteria are organized into categories and subcategories which are processed by a shipping options engine.

20. The method of claim 16, further comprising:
providing to one or more prospective carriers or shippers of the order product a request for bid based on the customer preferences and delivery options; and
submitting, by prospective carriers or shippers of the ordered product, bids to deliver the ordered product to the customer based on the customer preferences and the delivery options.

21. The method of claim 20, wherein the delivery options are adjusted by the carriers or shippers by providing incentives as part of the bids.

22. The method of claim 16, wherein the assessment criteria include a duration window, wherein the smaller the window or the more popular that window of time.

23. The method of claim 16, wherein providing the pricing includes at least one of:
calculating pricing options from shipping options;
calculating available incentives and promotions and adjusts pricing model;
recording a history of pricing selected for future pricing options; and
aligning shipping options with customer preferences for lowest shipping.

24. A method for shipping, comprising:
computing by a shipping options engine a shipping options, shippers, and bids matrix that includes a set of possible combinations and initial pricing;
receiving a customer request;
presenting in response to the customer request shipping options in a set of possible combinations and initial pricing; and
generating available shipping options based upon match on customer preferences in the customer request.
